(19) United States
(12) Patent Application Publication
(10) Pub. No.: US 2018/0044081 A1
(43) Pub. Date: Feb. 15, 2018

(54) Collectibles With Bundling Strips And Methods of Manufacture Thereof

(71) Applicant: Mary Middelton O'Brien, Jacksonville, FL (US)

(72) Inventor: Mary Middelton O'Brien, Jacksonville, FL (US)

(21) Appl. No.: 15/673,369

(22) Filed: Aug. 9, 2017

Related U.S. Application Data
(60) Provisional application No. 62/373,104, filed on Aug. 10, 2016.

(51) Int. Cl. B65D 63/02; G06Q 30/06; A45D 40/24; A45D 42/10; B65D 71/50; B65D 73/00

(52) U.S. Cl. CPC B65D 63/02; B65D 71/50; B65D 73/0014; A45D 40/24; A45D 42/10; G06Q 30/0631

(57) ABSTRACT

The present disclosure relates generally to the bundling of objects for organization, portability, and ease of access and use. More specifically, the present disclosure describes collectibles with bundling strips that may allow for collectibles to bundle to each other. Further, the present disclosure relates to mechanisms that may allow for bundling and unbundling of an array of collectible items to one or more each other or collectors, including, for example, magnetism, temporary adhesion, or hook and eye loops. In some aspects, collectibles may comprise a range of functionality in conjunction with the bundling, including, for example, coupling devices that help a user identify, track, and measure orientation, statistics, and other needs as programmed or set by a user.

### CROSS-REFERENCE TO RELATED APPLICATION

This application claims priority to and the full benefit of U.S. Provisional Patent Application Ser. No. 62/373,104 filed Aug. 10, 2016, and titled “COLLECTIBLES WITH BUNDLING STRIPS AND METHODS OF MANUFACTURE THEREOF”, the entire contents of which are incorporated by reference.

### BACKGROUND OF THE DISCLOSURE

Traditionally, human beings were limited on how many and as to what items they could carry. Originally, the limit was based on how much a single individual or a group could hold. If there were too many items, this required multiple trips or creative ways to transport materials or belongings. Over time, human beings started creating other means to be able to increase their capacity, creating bags to carts to carriages to cargo and everything in between.

Eventually, consumers gained the means of owning automobiles, which in itself naturally allowed the carriage, stowage, and transportation of more items. In conjunction with this increased accessibility of storage on a larger scale, people coupled this ease of use with bags, purses, or briefcases that they could carry from place to place, such as to and from work. This portability of item-carrying storage units, particularly when combined with the ability to operate automobiles, lead to people naturally reaching for essentials while driving.

For example, it is not uncommon for someone to reach into their purse to get a cosmetic item while driving, such as lipstick. Due to society's increased mobility, combined with long commutes, hectic schedules, or a need to touch up or present oneself at their best between meetings or functions, it is not uncommon for someone to take their eyes off the road in search for something to touch up their makeup. This distracts from driving, endangers other drivers, and causes frustration when a sought after item is not quickly accessible. The longer someone searches around in their purse, the more dangerous it is for everyone.

### SUMMARY OF THE DISCLOSURE

What is needed, therefore, is a means of organization that allows someone to quickly identify a necessary item in as safe a method as possible, or to collect loose items to make future identification and use simple, easy, and quick. If a person is able to achieve this, such as in the example described above, it will reduce frustration, increase the safety of others, and facilitate organization.

Accordingly, the present disclosure relates generally to the bundling of objects for organization, portability, and ease of access and use. More specifically, the present disclosure describes collectibles with bundling strips that may allow for collectibles to bundle to each other. Further, the present disclosure relates to mechanisms that may allow for bundling and unbundling of an array of collectible items to one or more each other or collectors, including, for example, magnetism, temporary adhesion, or hook and eye loops. In some aspects, collectibles may comprise a range of functionality in conjunction with the bundling, including, for example, coupling devices that help a user identify, track, and measure orientation, statistics, and other needs as programmed or set by a user.

Some general aspects may comprise a collectible with a bundling strip, which may include a collectible body; a bundling strip located on or within the collectible body, wherein the bundling strip may include a collecting mechanism that is configured to aggregate a plurality of collectibles with bundling strips. Implementations may include one or more of the following features. In some aspects, at least a portion of the bundling strip may include a magnetic material. In some embodiments, the collectible may include a cosmetic, such as a lipstick. In some implementations, the collectible body may include a base configured to contain a substance and a lid removably attachable to the base. In some aspects, the bundling strip may be located on or within the lid. In some embodiments, the bundling strip may be removable.

Some general aspects may comprise a bundling system that may include a collector, which may include a first collecting mechanism that is configured to aggregate a plurality of collectibles with bundling strips, and at least one collectible with bundling strip, wherein the at least one collectible may include a collectible body. The bundling system may include a bundling strip, wherein the bundling strip may be located on the collectible body, and wherein the bundling strip may include a second collecting mechanism that is configured to connect to the collector.

Implementations may include one or more of the following features. In some aspects, the collector may comprise a magnetic bar. In some implementations, at least a portion of the bundling strip may include a magnetic portion that is attractive to the collector. In some embodiments, the bundling strip may include a metal attractive to the collector. In some aspects the collectible may comprise a cosmetic. In some implementations, the second collecting mechanism may be further configured to connect to other collectibles.

Some general aspects may comprise an adapter bundling strip for bundling collectibles, wherein the adapter bundling strip may include an adapter body configured to secure the adapter bundling strip to a collectible, and a bundling strip located on the adapter body, wherein the bundling strip may include a collecting mechanism that is configured to aggregate a plurality of collectibles with bundling strips.

Implementations may include one or more of the following features. In some embodiments, the adapter body may include an adhesive backing configured to adhere to the collectible. In some aspects, the adapter body may comprise a sleeve configured to fit over the collectible. In some implementations, the adapter body may comprise a wrap configured to wrap around the collectible, wherein the wrap may include a first connector mechanism located on an edge of the wrap and a second connector mechanism located on a distal edge to the first connector mechanism, wherein connecting the first connector mechanism to the second connector mechanism secures a position of the wrap around the collectible. In some aspects, the collectible may comprise a cosmetic. In some embodiments, the adapter body may comprise neoprene. In some implementations, at least a portion of the bundling strip may include a magnetic material.

### BRIEF DESCRIPTION OF THE DRAWINGS

The accompanying drawings, that are incorporated in and constitute a part of this specification, illustrate several embodiments of the disclosure and, together with the description, serve to explain the principles of the disclosure:

FIG. 1 illustrates exemplary collectibles.

FIG. 2A illustrates an exemplary collectible with bundling strip.

FIG. 2B illustrates exemplary embodiments of incorporating a bundling strip into a collectible wall.

FIG. 2C illustrates exemplary embodiments of incorporating a bundling strip into a collectible wall.

FIG. 2D illustrates an exemplary bundling strip that may be integrated into a pocket within at least a portion of the collectible wall.

FIG. 3 illustrates exemplary embodiments of collectibles and adapter bundling strips.

FIG. 4 illustrates an exemplary embodiment of a lip-gloss collectible and adapter bundling strip.

FIG. 5 illustrates an exemplary embodiment of a lip moisturizer collectible and an adapter bundling strip.

FIG. 6A illustrates an exemplary cosmetic case collectible with bundling strip.

FIG. 6B illustrates an exemplary cosmetic case collectible with a content indicator and content sensor.

FIG. 6C illustrates an exemplary cosmetic case collectible with a content indicator and content sensor.

FIG. 7A illustrates an exemplary embodiment of a lipstick collectible with a content indicator and sensor.

FIG. 7B illustrates an exemplary embodiment of a lipstick collectible with a content indicator and sensor.

FIG. 7C illustrates an exemplary embodiment of a lipstick collectible with a content indicator and sensor.

FIG. 8A illustrates an exemplary embodiment of a lipstick collectible with a bundling activator.

FIG. 8B illustrates an exemplary embodiment of a lipstick collectible with a bundling activator.

FIG. 9 illustrates an exemplary bundle of smart lipstick collectibles with bundling strips and a paired external device.

FIG. 10A illustrates an exemplary vessel collector with horizontal bundling.

FIG. 10B illustrates an exemplary vessel collector with vertical bundling strips.

FIG. 10C illustrates an exemplary bundling system comprising a vessel collector with vertical bundling strips and bundled collectibles.

FIG. 11A illustrates an exemplary central collector with a series of bundling strips.

FIG. 11B illustrates an exemplary bundling system with central collector with a series of bundling strips and bundled collectibles.

FIG. 12A illustrates an exemplary organizing collector.

FIG. 12B illustrates an exemplary bundling system with organizing collector and a variety of bundled collectibles.

FIG. 13 illustrates an exemplary processing and interface system.

### DETAILED DESCRIPTION

The present disclosure provides generally for a means of organization and accessibility of products. Accordingly, the present disclosure relates generally to bundling of objects for organization, portability, and ease of access. More specifically, the present disclosure describes collectibles with bundling strips that may allow for collectibles to bundle to each other. Further, the present disclosure relates to mechanisms that may allow for bundling and unbundling of an array of collectible items to one or more each other or collectors, including, for example, magnetism, temporary adhesion, or hook and eye loops. In some aspects, collectibles may comprise a range of functionality in conjunction with the bundling, including, for example, coupling devices that help a user identify, track, and measure orientation, statistics, and other needs as programmed by a user.

In the following sections, detailed descriptions of examples and methods of the disclosure will be given. The description of both preferred and alternative examples, though thorough, are exemplary only, and it is understood that to those skilled in the art variations, modifications, and alterations may be apparent. It is therefore to be understood that the examples do not limit the broadness of the aspects of the underlying disclosure as defined by the claims.

### Glossary

Collectible: as used herein refers to an object that may be bundled. In some aspects, a collectible may comprise a bundling strip. In some embodiments, a collectible may be fitted for a bundling strip.
Collector: as used herein refers to a device that may aggregate collectibles. In some embodiments, a collector may comprise a vessel, wherein the vessel collector may house the collectible. In some aspects, a collector may comprise a central mechanism, wherein a collectible may be bundled around the central collector.
Bundling Strip: as used herein refers to a mechanism that may be attached to or integrated into a collectible, wherein the bundling strip may cause multiple collectibles to bundle to one or both each other or collectors.

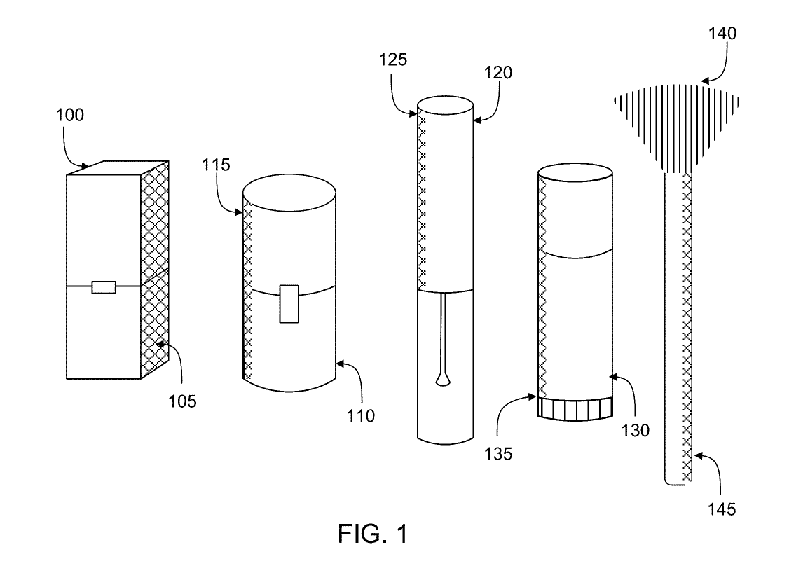

Referring now to FIG. 1, exemplary collectibles 100, 110, 120, 130, 140 are illustrated. In some aspects, collectibles 100, 110, 120, 130, 140 may comprise cosmetics and cosmetic accessories. For example, collectibles may include lipstick tubes 100, 110 of various shapes, wherein a portion of the lipstick tube 100, 110 may comprise a bundling strip 105, 115. In some embodiments, a collectible may comprise a lip-gloss 120 or a lip moisturizer 130, wherein each may comprise a bundling strip 125, 135. In some implementations, a collectible may comprise a cosmetic brush 140 with a bundling strip 145.

In some aspects, collectibles may comprise elements and accessories from a themed group of objects. For example, as illustrated, the collectibles may comprise cosmetics and cosmetic accessories. More specifically, the collectible may comprise lip applications 100, 110, 120, 130, wherein the bundling strips 105, 115, 125, 135 may bundle the lip applications 100, 110, 120, 130 allowing a user to organize and easily access their lip applications 100, 110, 120, 130. For example, a user may carry a handful of lip applications 100, 110, 120, 130 in their purse or bag, and the bundling may make it easier for the user to locate all the lip applications 100, 110, 120, 130 at once.

In some implementations, collectible may comprise a lid and a base, wherein the lid may be removably attachable to the base. For example, the collectible may comprise a lipstick 100, 110, lip gloss 120, or lip balm 130, wherein the base may comprise the cosmetic substance. In some aspects, a bundling strip may be located on one or both the lid and the base. For example, the bundling strip 125 of a lip gloss 120 may be located only on the lid.

In some aspects, the group of collectibles may relate to firearms or firing mechanisms, such as, for example, ammunition, arrows, shells, magazines, holster, firearms, sights, and other accessories. In some aspects, a holster may comprise a bundling strip, wherein additional shells or magazines may be bundled and easily accessed as needed.

In some embodiments, the group of collectible may relate to eye care, such as, for example, solution, glasses, lens cases, and other eye care products. In some aspects, lenses for an eyeglass frame may be interchangeable wherein a user may select lenses of different tints depending on function, light exposure, and style, as non-limiting examples. For example, a user may use clear lenses indoors, but may want to change to a darker lens for a sunny day. Similarly, a user may prefer a blue tint for some activities, such as golf, and orange for others, such as tennis or fishing.

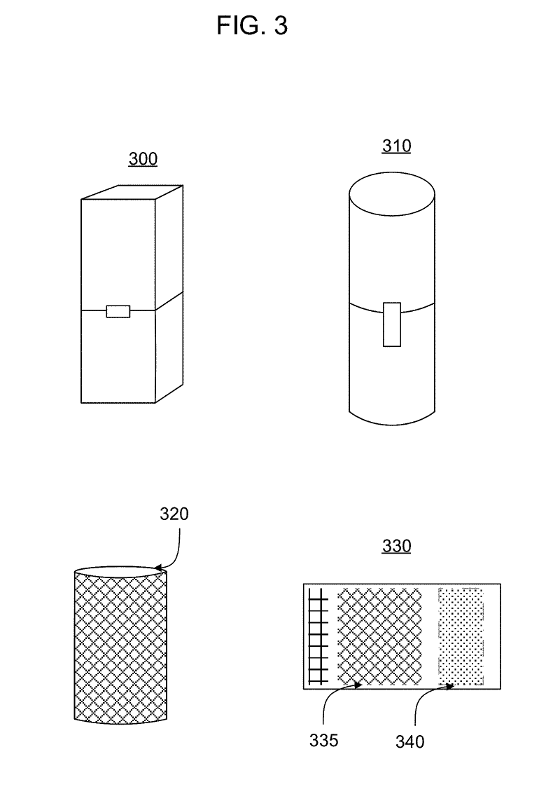

In some implementations, the group of collectibles may relate to health care, such as, for example, components of a first aid kit, medical tools, or other health care products. In some aspects, collectibles may comprise the personal belongings of a patient that may be bundled with the patient's bed. For example, a patient may be prepared for surgery, and her eyeglasses and hearing aid may be removed, which may be important for the patient to have immediate access to those belongings post-surgery. A nurse may bundle the eyeglasses and the hearing aid to her bed or to her status files that may follow her between procedures. The eyeglasses and hearing aid may be bundled through an adapter, as illustrated in FIGS. 3-5 herein.

In some aspects, the group of collectibles may relate to personal care, such as, for example, hair accessories, including clips, bobby pins, combs, rollers, razors, and disposable blades. In some implementations, the group of collectibles may relate to gaming, such as, for example, game pieces, console components, poker chips, and other gaming accessories. In some embodiments, the group of collectibles may relate to electronics, such as, for example, cables, cords, adapters, batteries, remotes, and other electronic products.

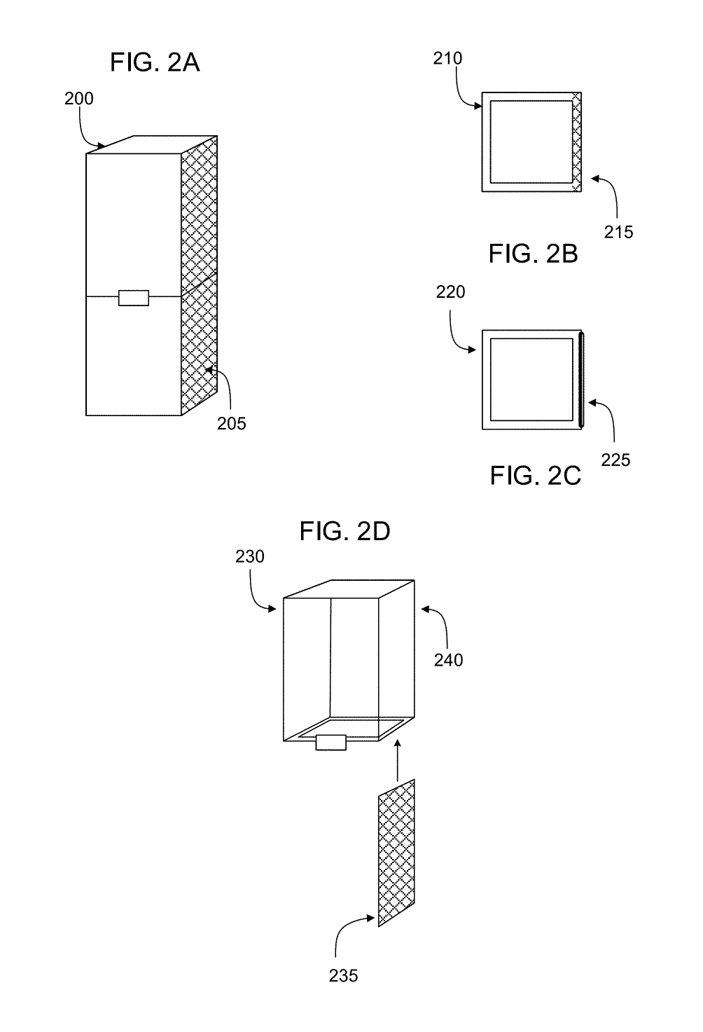

Referring now to FIG. 2A, an exemplary collectible 200 with bundling strip 205 is illustrated. Referring to FIGS. 2B-2C, exemplary embodiments of incorporating a bundling strip 215, 225, 235 into a collectible wall 210, 220, 230 is illustrated. In some aspects, such as illustrated in FIG. 2B, a bundling strip 215 may be integrated into the material for at least one side of the collectible wall 210. For example, one side of the collectible wall 210 may comprise a magnetic strip.

In some embodiments, such as illustrated in FIG. 2C, a bundling strip 225 may be attached or adhered to a portion of the collectible wall 220. For example, a magnetic liquid may be painted onto a portion of the collectible wall 220. As another example, a magnetic strip may be glued onto a portion of the collectible wall 220. In some embodiments, a bundling strip may be “deactivated,” wherein the deactivation may occur by blocking the bundling strip mechanically. For example, where the bundling strip may comprise a magnetic material, the bundling strip may be blocked from bundling with other collectibles by applying a second magnetic strip with opposite polarization, wherein the back of the second magnetic strip may not comprise a bundling strip.

In some aspects, such as illustrated in FIG. 2D, a bundling strip 235 may be integrating the bundling strip 235 into a pocket 240 within at least a portion of the collectible wall 230. In some embodiments, the insertion of the bundling strip 235 may occur during the manufacturing process, making the insertion permanent. In some implementations, the insertion of the bundling strip 235 may be temporary, allowing a user to remove the bundling strip 235 from the collectible wall 230, wherein the removal may “deactivate” the collectible.

Referring now to FIG. 3, exemplary embodiments of collectibles 300, 310 and adapter bundling strips 320, 330 are illustrated. In some aspects, bundling strips may not be integrated into the lipstick collectible 300, 310, and adapter bundling strips 320, 330 may be used to add bundling strips to collectibles. In some embodiments, a sleeve adapter bundling strip 320 may be slipped over collectibles of various shapes and sizes, such as a cuboidal lipstick collectible 300 or a cylindrical lipstick collectible 310. In some aspects, a wrap adapter bundling strip 330 may comprise a bundling strip 335 and a connector mechanism 340 that may secure the wrap adapter bundling strip 330 around the collectible.

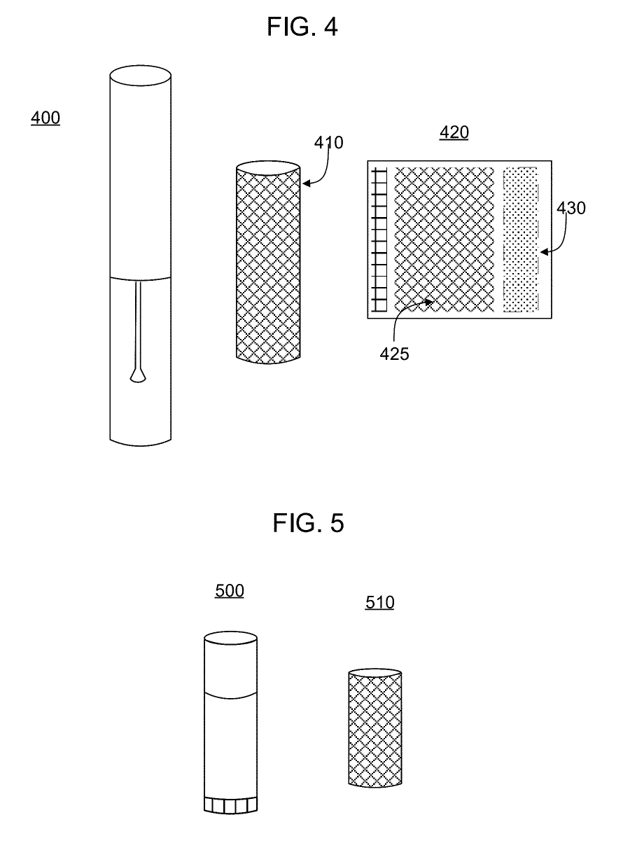

Referring now to FIG. 4, an exemplary embodiment of a lip-gloss collectible 400 and adapter bundling strips 410, 420 are illustrated. In some aspects, adapter bundling strips 410, 420 may be used to add bundling strips to a lip-gloss collectible 400. In some embodiments, a sleeve adapter bundling strip 410 may be slipped over collectibles of various shapes and sizes, such as a a cylindrical lip-gloss collectible 400. In some aspects, a wrap adapter bundling strip 420 may comprise a bundling strip 425 and a connector mechanism 430 that may secure the wrap adapter bundling strip 420 around the collectible.

Referring now to FIG. 5, an exemplary embodiment of a lip moisturizer collectible 500 and an adapter bundling strip 510 are illustrated. In some aspects, an adapter bundling strip 510 may be used to add bundling strips to a lip moisturizer collectible 500. In some embodiments, a sleeve adapter bundling strip 510 may be slipped over collectibles of various shapes and sizes, such as a cylindrical lip moisturizer collectible 500.

In some aspects, a sleeve adapter bundling strip 510 may be a flexible material, wherein a sleeve adapter bundling strip 510 may fit over a range of collectible shapes and sizes, such as those illustrated and described in FIGS. 1, 3, 4. As non-limiting examples, the flexible material may comprise neoprene, elastic, rubberized material, pliable plastics, or polymers such as silicone. In some aspects, an attractive component may be integrated into the adapter bundling strip, such as where attractive material may be mixed with the flexible material. For example, magnetic material may be mixed with silicone prior to polymerization, wherein polymerization may suspend the magnetic material within the silicone. In some aspects, where the sleeve adapter bundling strip 510 may comprise a fabric, attractive material may be interwoven into the fabric.

In some embodiments, attractive material may be adhered to at least a portion of the sleeve adapter bundling strip 510. For example, magnetic paint may be added to the surface of the sleeve adapter bundling strip 510. As another example, magnetic strips may be adhered to the surface of the sleeve adapter bundling strip 510. In some aspects, patches of non-elastic attractive material may be attached as connective strips between elastic portions of the sleeve adapter bundling strip 510. For example, thin strips of rigid ferromagnetic material may be connected by flexible strips of elastic or neoprene. In some implementations, the rigid portions may be adhered to the flexible strips, such as by a heat seal or adhesives, or may be connected to the flexible strips, such as by weaving the flexible strips into eye loops extending from the rigid portion.

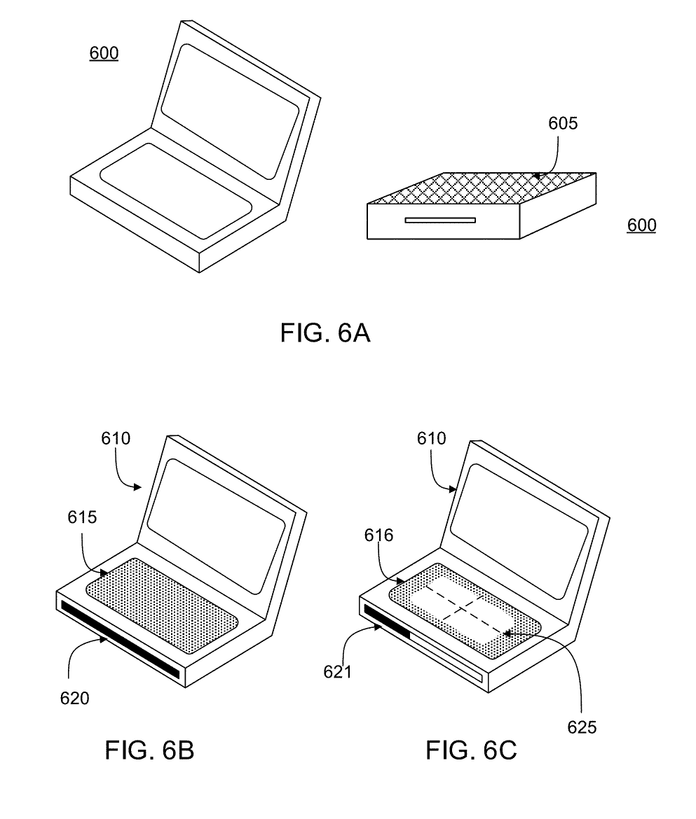

Referring now to FIG. 6A, an exemplary cosmetic case collectible 600 with bundling strip 605 is illustrated. In some aspects, a cosmetic case collectible 600 may comprise a bundling strip 605 on top of the outer casing. The bundling strip 605 may allow a user to bundle various cosmetic sets, such as the brushes used with the makeup in the cosmetic case collectible 600 or other cosmetic case collectibles that may be stacked for easy transport and organization.

In some embodiments, cosmetic collectibles for a single makeup look may be bundled. For example, a smoky eye look may require an eye pencil, two eye shadow colors, a neutral blush, a lip stain, and four different brushes. All of the component collectibles may comprise a bundling strip, which may be integrated or adapted into the collectible. The makeup set may be bundled for organization.

Referring now to FIGS. 6B-6C, an exemplary cosmetic case collectible 610 with a content indicator 620 and content sensor 625 is illustrated. In some aspects, a user may want to monitor the content of the makeup 615 within a cosmetic case collectible 610. A content indicator 620 may indicate a relative amount of makeup 615 within the cosmetic case collectible 610, wherein a content indicator 620 may show “full” when little to no makeup 615 has been used. In some aspects, the content indicator 621 may indicate the relative amount of makeup 616 remaining in the cosmetic case collectible 610.

In some embodiments, a sensor 625 may be located proximate to the makeup 616, wherein the sensor 625 may determine the relative remaining amount of makeup 616 based on predefined parameters. For example, the sensor 625 may detect light exposure, wherein a range of light levels may be preprogrammed into the device. In some aspects, a user may calibrate the sensor 625, wherein the calibration may reduce false detection of limited light exposure where the ambient light may be dimmed.

In some embodiments, a cosmetic case collectible 610 may comprise an internal light (not shown). The internal light may illuminate a mirror portion for easier application of the makeup 616. In some aspects, the internal light may briefly turn on when the cosmetic case collectible 610 may be closed, wherein the predefined parameters for the sensor 625 may be based on light exposure levels detected from the internal light. Utilizing an internal light may limit false or misleading detection of light levels of ambient light, which may inherently be variable.

In some aspects, the internal light may comprise a low energy, low visibility wavelength, which may limit energy use. In some aspects, such as where the makeup 616 may be replaceable for a cosmetic case collectible 610, the sensor mechanism may comprise a rechargeable power source, such as solar power. In some aspects, the internal light may comprise a disinfecting wavelength, such as ultraviolet, wherein an activation of the internal light may disinfect one or more the surfaces, brushes, or the makeup 615, 615 within the cosmetic case collectible 610. A disinfecting mechanism may extend the hygienic life of the cosmetic case collectible 610 and limit risk of infection associated with contaminated and old makeup 615, 616 and dirty makeup brushes.

In some aspects, the cosmetic case collectible 610 may comprise an indicator control (not shown), which may allow a user to control one or more functions of the cosmetic case collectible 610. For example, an indicator control may allow a user to operate the sensor mechanism, such as to prompt activation of the content indicator 620, 621; to control the illumination of the internal light; or to calibrate the sensor when replacing the makeup portion of the cosmetic case collectible 610.

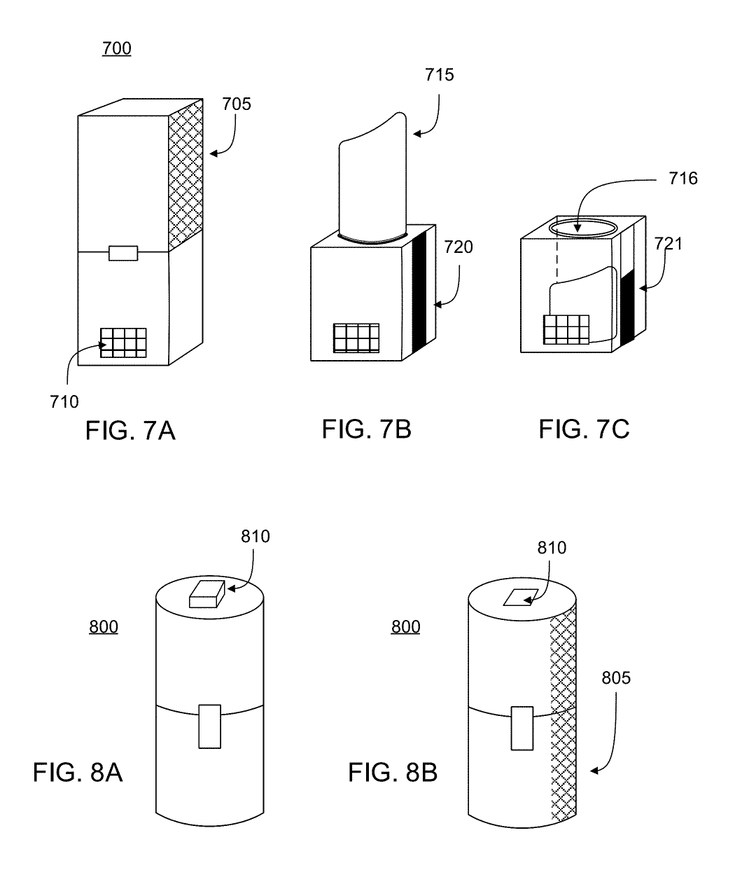

Referring now to FIGS. 7A-7C, an exemplary embodiment of a lipstick collectible 700 with a content indicator 720, 721 and sensor 710 is illustrated. In some aspects, the sensor 710 may be programmed to detect a content level of the makeup 715, 716 within the lipstick collectible 700. In some embodiments, the sensor 710 may detect a relative amount of makeup 715, 716 and transmit the detected level to the content indicator 720, 721. The sensor 710 may provide additional functionality. For example, the sensor 710 may detect a threshold content, which may trigger a notification that the user may want to purchase another lipstick. In some aspects, the sensor 710 may interface with an external computing device, such as a smartphone or other handheld device, which may receive transmitted notifications.

In some aspects, the sensor 710 may detect the true color of the lipstick, and the content indicator 720, 721 may indicate that color. For example, some lipsticks come with a sticker that indicates the color, and many only have the name of the color, which is often a playful but not necessarily informative word or phrase. The sensor 710 may periodically scan the surface of the lipstick and transmit the information to the content indicator 720, 721, wherein the color of the content indicator 720, 721 may adjust according to the transmission. In some implementations, at least a portion of the content indicator 720, 721 may comprise a liquid crystal display, which may allow for a range of colors that may provide precise color matching.

Referring now to FIGS. 8A-8B, an exemplary embodiment of a lipstick collectible 800 with a bundling activator 810 is illustrated. In some aspects, a user may be able to control the bundling strip 805, wherein the control may allow a user to activate and deactivate the bundling strip 805. For example, a bundling activator 810 may be pressed down to activate the bundling strip 805, allowing the lipstick collectible 800 to bundle with other collectibles.

In some embodiments, a user may prefer a loose lipstick collectible 800 in a small clutch, wherein the bundling strip 805 may not attract the lipstick collectible 800 to metal supports in the clutch. In some aspects, the user may activate the lipstick collectible 800, wherein the bundling strip may attract car keys and loose change, allowing for immediate organization within the clutch.

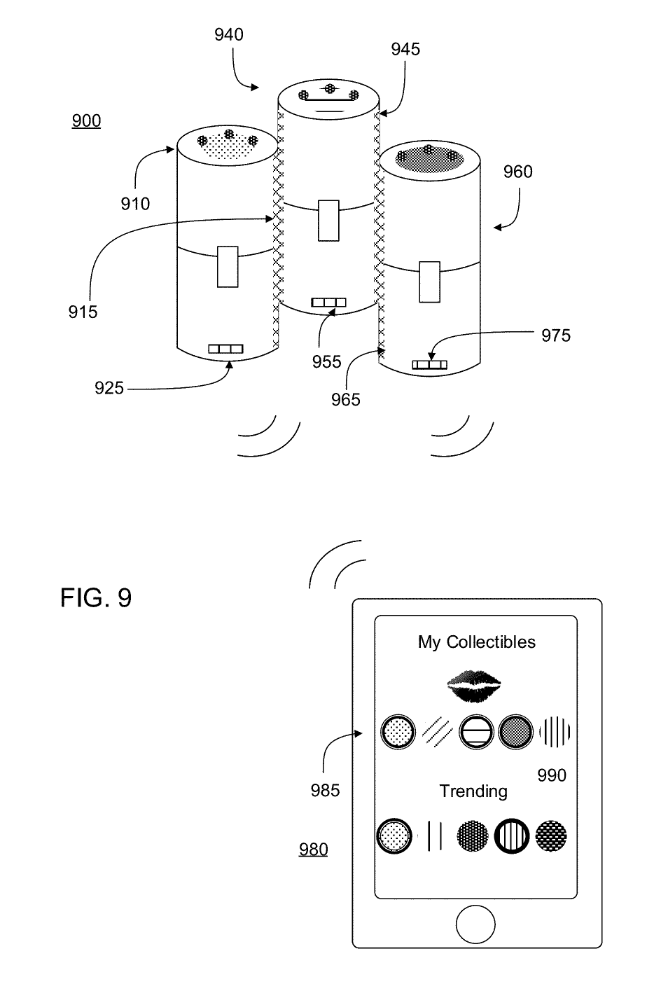

Referring now to FIG. 9, an exemplary bundle 900 of smart lipstick collectibles 910, 940, 960 with bundling strips 915, 945, 965 and a paired external device 980 are illustrated. In some aspects, smart lipstick collectibles 910, 940, 960 may comprise a range of characteristics and mechanisms that may add functionality. For example, the lipstick collectibles 910, 940, 960 may comprise sensors 925, 955, 975. The sensors 925, 955, 975 may detect internal features and characteristics of the smart lipstick collectible 910, 940, 960, such as makeup content levels, bacteria levels, color, temperature, use of the makeup, as non-limiting examples.

In some aspects, the sensors 925, 955, 975 may communicate between smart lipstick collectibles 910, 940, 960 and other external devices 980. For example, the sensors 925, 955, 975 may recognize when another smart lipstick collectible is within attractive proximity, wherein proximity may activate bundling strips 915, 945, 965, allowing the smart lipstick collectibles 910 to bundle. The sensors 925, 955, 975 may recognize when an external device 980, such as a smartphone, is located within communication distance, wherein the external device 980 may communicate by one or both receiving or transmitting information.

For example, as the smart lipstick collectibles 910, 940, 960 are bundled, the external device 980 may receive a notification and indicate some information related to the smart lipstick collectibles 910, 940, 960. The information may include color, brand, content level, date of last use, number of uses, as non-limiting examples. In some aspects, the external device may provide that information directly.

In some embodiments, the external device 980 may process the information, wherein a user may access the information and related information. For example, the external device 980 may log each use of the smart lipstick collectibles 910, 940, 960, wherein the external device 980 may be able to track the popularity of a particular color or brand. The popularity may be tracked based on a single user or multiple users of the smart lipstick collectibles 910, 940, 960.

In some aspects, the external device 980 may comprise a graphical user interface (GUI) that presents a bank 985 of collectibles that a user may have logged in their profile, which may be organized by collectible type, such as lip cosmetics, eye cosmetics, or hairstyle components. The GUI may present the bank 985 and highlight the activated smart lipstick collectibles 910, 940, 960. In some embodiments, the GUI may present trending collectibles 990, which may show popular collectibles. For example, the popularity may be determined by the number of purchasers. As another example, the popularity may be determined by current active collectibles. In some aspects, the tracking of active collectibles may pair with social media sites, such as Facebook, Twitter, or Instagram.

In some implementations, a smart lipstick collectible may include near-field communication protocols to enable two devices when they are brought into proximity with one another. For example, a smart lipstick collectible may be brought towards a phone and the phone may access a data set showing the popularity of the color selected, what other products it pairs with, and other relevant information. A smart lipstick collectible may also ping or vibrate when it is brought within range of another cosmetic item within its pairing family. For example, when a user is in a store trying to find the other item that is recommended when a cosmetic item is brought towards the phone, it will begin to rumble when the user passes over the other item, such as mascara.

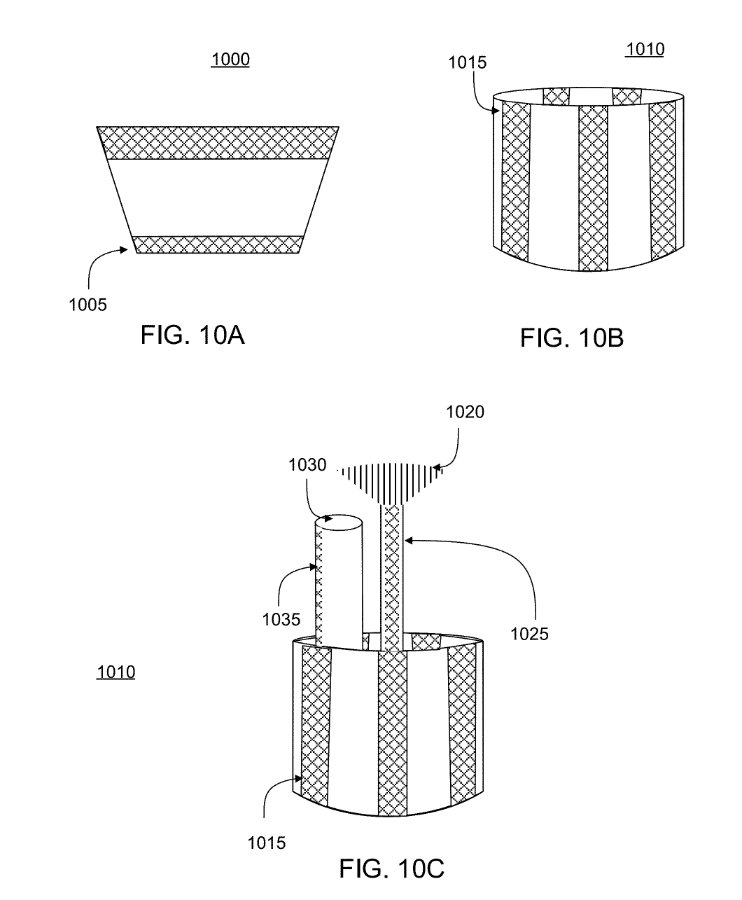

Referring now to FIG. 10A, an exemplary vessel collector 1000 with horizontal bundling strips 1005 is illustrated. Referring now to FIG. 10B, an exemplary vessel collector 1010 with vertical bundling strips 1015 is illustrated. Referring now to FIG. 10C, an exemplary bundling system comprising a vessel collector 1010 with vertical bundling strips 1015 and bundled collectibles 1030, 1020 with bundling strips 1035, 1025 is illustrated.

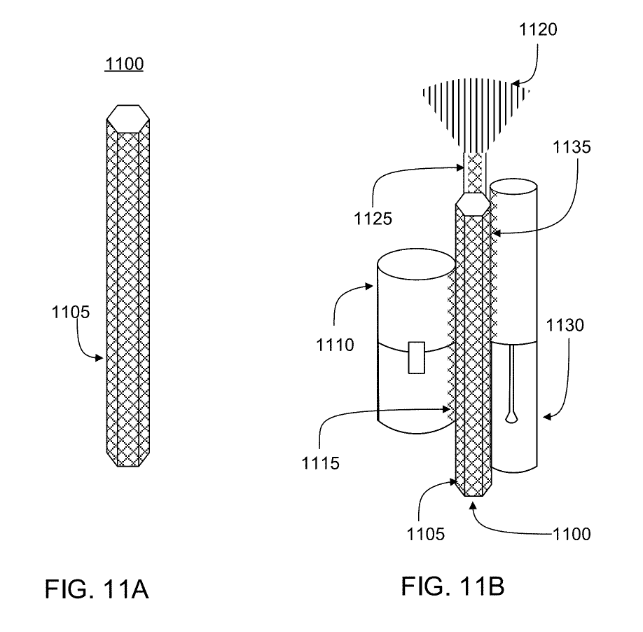

Referring now to FIG. 11A, an exemplary central collector 1100 with a collecting mechanism, wherein the collecting mechanism comprises a series of bundling strips, 1105 is illustrated. A central collector 1100 may expand the number of collectibles that may be bundled. For example, without a central collector 1100, four collectibles with a bundling strip on one side may be bundled naturally. Using a central collector 1100, those four may be expanded based on the bundling strip 1105 configuration of the central collector 1100. Referring now to FIG. 11B, an exemplary central collector 1100 with bundled collectibles 1110, 1120, 1130 with bundling strips 1115, 1125, 1135 is illustrated.

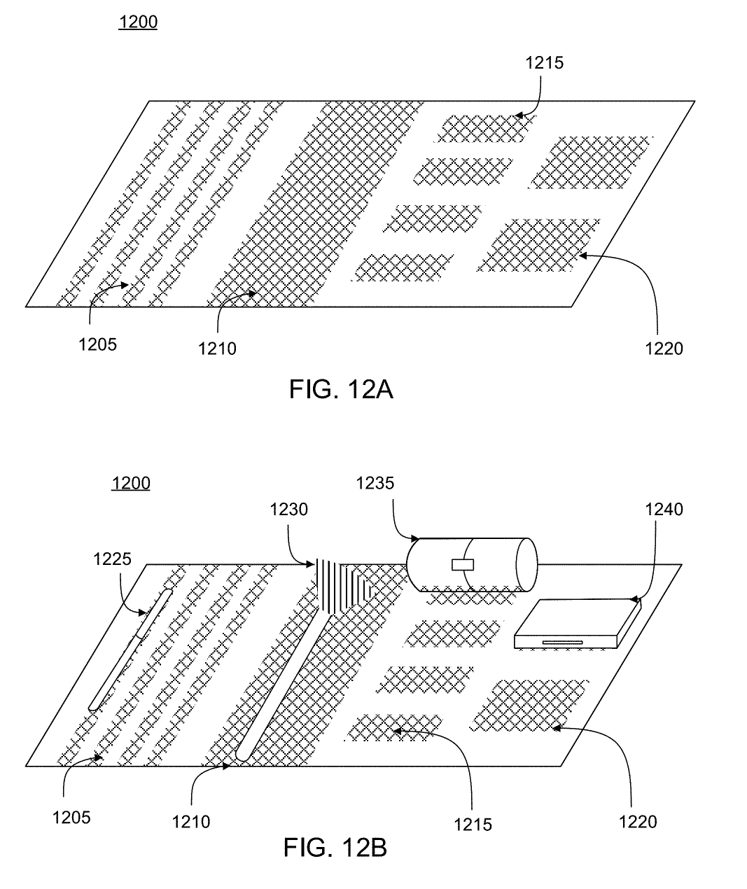

Referring now to FIG. 12A, an exemplary organizing collector 1200 is illustrated. In some aspects, an organizing collector 1200 may comprise a collecting mechanism, such as a series of bundling strips 1205, 1210, 1215, 1220, wherein each series of bundling strips 1205, 1210, 1215, 1220 may be a variety of shapes and sizes. Referring now to FIG. 12B, an exemplary bundling system comprising an organizing collector 1200 with a variety of bundled collectibles 1225, 1230, 1235, 1240 is illustrated.

For example, long, thin bundling strips 1205 may be useful for small collectibles or thin collectibles, such as pencils or eyeliners 1225. A broad, long bundling strip 1210 may be useful to bundle a group of long, thin collectibles, such as brushes 1230, or broad collectibles, such as an eyeglass case. Short bundling strips 1215 may be useful for short, wide collectibles, such as lipsticks 1235, or for a group of thin, short collectibles, such as bobby pins. Rectangular bundling strips 1220 may be useful for flat collectibles, such as cosmetic cases 1240.

In some aspects, an organizing collector may comprise a partially flexible material, wherein the organizing collector may be collapsible. In some embodiments, the organizing collector may comprise variations in polarity, wherein the variable polarity may maintain the organization, even when the organizing collector is collapsed. For example, the organizing collector may be a portable cosmetic bag, wherein cosmetic collectibles may be organized, bundled, and transported. As another example, an organizing collector may be a first aid kit, and the collectibles may include bandages, ointments, scissors, salves, wraps, and other first aid components.

In some aspects, the organizing collector may allow organization of professional tools. For example, each organizing collector may comprise the base dental tools for a standard cleaning. Opening the organizing collector may break a sterile seal, allowing a dentist to access the tools, which may then be put into a sterilization mechanism along with the organizing collector for the next use.

In some embodiments, the organizing collector may allow for vertical arrangement of collectibles, wherein the bundling strip may be strong enough to allow for bundling beyond an intermediate object. For example, an organizing collector may allow for a nail-less hanging of collectibles against a wall, wherein the organizing collector may be placed on one side of the wall and the collectible may be placed on the other side of the wall to be mounted. As illustrative examples, mounted collectibles may include decorations, photographs, hooks, paintings, clocks, or other mountable objects.

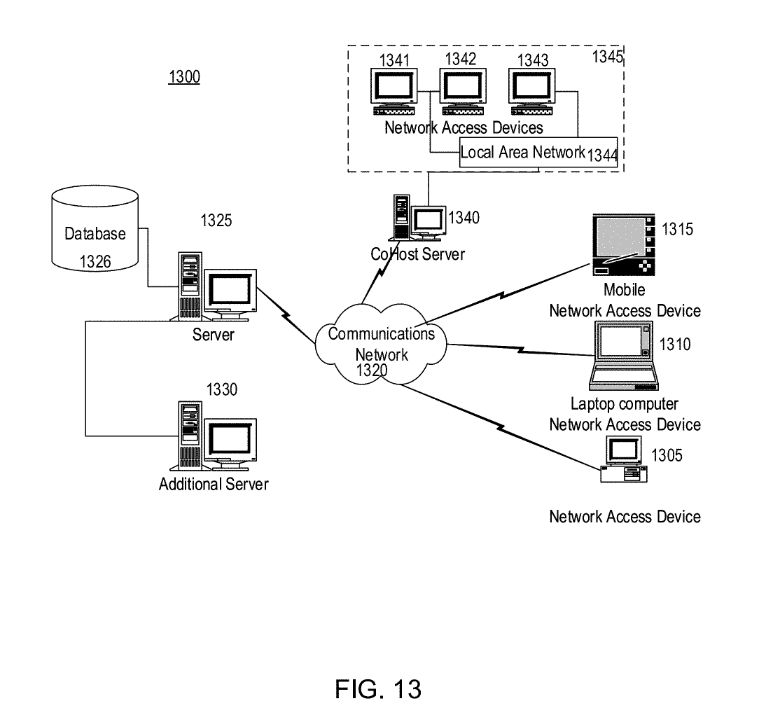

Referring now to FIG. 13, an exemplary processing and interface system 1300 is illustrated. In some aspects, access devices 1315, 1310, 1305, such as a mobile device 1315 or laptop computer 1310 may be able to communicate with an external server 1325 though a communications network 1320. The external server 1325 may be in logical communication with a database 1326, which may comprise data related to identification information and associated profile information. In some examples, the server 1325 may be in logical communication with an additional server 1330, which may comprise supplemental processing capabilities.

In some aspects, the server 1325 and access devices 1305, 1310, 1315 may be able to communicate with a cohost server 1340 through a communications network 1320. The cohost server 1340 may be in logical communication with an internal network 1345 comprising network access devices 1341, 1342, 1343 and a local area network 1344. For example, the cohost server 1340 may comprise a payment service, such as PayPal or a social network, such as Facebook or a dating website.

In some aspects, collectibles may comprise clothing, such as for activities that may expose a participant to a range of ambient conditions. For example, activities that may extend for long periods of time, such as distant hiking, distant cycling, hunting, fishing, or camping, may expose participants to cold, damp conditions in the morning; sun and heat in the afternoon; and dry, cool conditions in the night. Accordingly, clothing may be adaptable to a range of conditions, wherein an item of clothing may comprise a series of collectibles that may be bundled and unbundled as a way to adjust to the changing conditions.

In some aspects, collectors may allow for safe and organized bundling. In some embodiments, tools and hobby components may be bundled and oriented, to allow for quick and safe access. For example, needle collectibles for sewing or knitting may be oriented within a collector wherein the sharp ends are oriented away from the opening, limiting exposure of the sharp ends.

In some aspects, a collector may comprise a wearable mp3 player holder, wherein collectibles may include an mp3 player, headphones, keys, and a wallet, wherein the collector may allow a runner to exercise with music and other components the runner may carry. In some aspects, collectibles may comprise sport components, such as water bottles, horse whips, extra balls, as non-limiting examples.

In some embodiments, collectibles may comprise components for an activity. For example, cleaning collectibles may include brushes, sponges, brooms, vacuum components, and cleaning solutions. As another example, a gardening set may include a collector belt, which may organize a range of gardening tools, such as shovels and hoes. The collector belt may be removed and carried over a lawn, collecting scattered collectibles that a gardener may have accidentally left on the lawn. As another example, art collectibles may include brushes, paints, pencils, and sponges.

Other collectibles may include kitchen utensils, which may comprise bundling strips that allow for nested bundling; jewelry, which may benefit from an organizing collector to couple earrings and limit tangling of necklaces; office supplies; toys; automobile components, such as a collectible tire air cap, wherein the air cap may bundle with the hub cap to limit the chance of losing the air cap; pet supplies, such as a leash, collar, and waste bags; medications, such as pill containers or liquid medications with dispensers; public safety components, such as fire hoses to fire extinguisher lines; baby supplies, such as pacifiers and teething devices; keepsakes; and other miscellaneous items, such as reusable grocery bags, which may be adapted into collectibles with an adhesive or ring adapter.

### CONCLUSION

A number of embodiments of the present disclosure have been described. While this specification contains many specific implementation details, these should not be construed as limitations on the scope of any disclosures or of what may be claimed, but rather as descriptions of features specific to particular embodiments of the present disclosure.

Certain features that are described in this specification in the context of separate embodiments can also be implemented in combination in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order show, or sequential order, to achieve desirable results. In certain implementations, multitasking and parallel processing may be advantageous. Nevertheless, it will be understood that various modifications may be made without departing from the spirit and scope of the claimed disclosure.

What is claimed is:

1. A collectible with bundling strip comprising:
a collectible body; and
a bundling strip located on or within the collectible body, and wherein the bundling strip comprises a collecting mechanism that is configured to aggregate a plurality of collectibles with bundling strips.

2. The collectible of claim 1, wherein at least a portion of the bundling strip comprises a magnetic material.

3. The collectible of claim 1, wherein the collectible comprises a cosmetic.

4. The collectible of claim 3, wherein the cosmetic comprises a lipstick.

5. The collectible of claim 1, wherein the collectible body comprises:
a base configured to contain a substance; and
a lid removably attachable to the base.

6. The collectible of claim 5, wherein the bundling strip is located on or within the lid.

7. The collectible of claim 1, wherein the bundling strip is removable.

8. A bundling system comprising:
a collector comprising a first collecting mechanism that is configured to aggregate a plurality of collectibles with bundling strips; and
at least one collectible with bundling strip, wherein the at least one collectible comprises:
a collectible body, and
a bundling strip, wherein the bundling strip is located on the collectible body, and wherein the bundling strip comprises a second collecting mechanism that is configured to connect to the collector.

9. The bundling system of claim 8, wherein the collector comprises a magnetic bar.

10. The bundling system of claim 9, wherein at least a portion of the bundling strip comprises a magnetic portion that is attractive to the collector.

11. The bundling system of claim 9, wherein the bundling strip comprises a metal attractive to the collector.

12. The bundling system of claim 8, wherein the collectible comprises a cosmetic.

13. The bundling system of claim 8, wherein the second collecting mechanism is further configured to connect to other collectibles.

14. An adapter bundling strip for bundling collectibles, the adapter bundling strip comprising:
an adapter body configured to secure the adapter bundling strip to a collectible; and
a bundling strip located on the adapter body, wherein the bundling strip comprises a collecting mechanism that is configured to aggregate a plurality of collectibles with bundling strips.

15. The adapter bundling strip of claim 14, wherein the adapter body comprises an adhesive backing configured to adhere to the collectible.

16. The adapter bundling strip of claim 14, wherein the adapter body comprises a sleeve configured to fit over the collectible.

17. The adapter bundling strip of claim 14, wherein the adapter body comprises a wrap configured to wrap around the collectible, and wherein the wrap comprises:
a first connector mechanism located on an edge of the wrap; and
a second connector mechanism located on a distal edge to the first connector mechanism, wherein connecting the first connector mechanism to the second connector mechanism secures a position of the wrap around the collectible.

18. The adapter bundling strip of claim 14, wherein the collectible comprises a cosmetic.

19. The adapter bundling strip of claim 14, wherein the adapter body comprises neoprene.

20. The adapter bundling strip of claim 14, wherein at least a portion of the bundling strip comprises a magnetic material.
